(19) United States
(12) Patent Application Publication
(10) Pub. No.: US 2014/0140077 A1
(43) Pub. Date: May 22, 2014

(54) Lamp and Lamp Holder Thereof

(71) Applicant: Shui-Mei Wang, New Taipei City (TW)

(72) Inventor: Shui-Mei Wang, New Taipei City (TW)

(21) Appl. No.: 14/073,050

(22) Filed: Nov. 6, 2013

(30) Foreign Application Priority Data
Nov. 21, 2012 (TW) 101143524

(51) Int. Cl. F21V 19/00

(52) U.S. Cl. CPC F21V 19/0025
USPC 362/382

(57) ABSTRACT

A lamp is disclosed. The lamp includes an illuminant and a lamp holder. The lamp holder includes a driving circuit board and a base body. The driving circuit board is connected to the illuminant. The driving circuit board includes a conductive part and a conductive fastening part. The base body includes a conductive case and a conductive contacting part. The conductive part connects the conductive case. The conductive contacting part is used for connecting the conductive fastening part.

### BACKGROUND OF THE INVENTION

1. Field of the Invention

The present invention relates to a lamp; more particularly, the present invention relates to a lamp with a lamp holder which is easy to assemble.

2. Description of the Related Art

In modern everyday life, the lamp is a necessary practical lighting device. In the structure of the lamp of the prior art, the bottom of the lamp holder is an electrode of the circuit, and the metal case around the lamp holder is another electrode of the circuit. In the production process of the lamp, the wire must be welded to the bottom of the lamp holder and the metal case around the lamp holder via a manual method, allowing the circuit of the lamp to be completed.

However, the manually welding process will greatly increase the time and labor cost; besides, the yield of the manually welding process is not stable, such that the yield of the production process will be hard to control.

Therefore, there is a need to provide a new lamp with a lamp holder which is easy to assemble.

### SUMMARY OF THE INVENTION

It is an object of the present invention to provide a lamp with a lamp holder which is easy to assemble.

To achieve the abovementioned object, the lamp of the present invention includes an illuminant and a lamp holder. The lamp holder includes a driving circuit board and a base body. The driving circuit board is connected to the illuminant. The driving circuit board includes a conductive part and a conductive fastening part. The base body includes a conductive case and a conductive contacting part. The conductive part is connected to the conductive case. The conductive contacting part is used for connecting to the conductive fastening part.

According to one embodiment of the present invention, the conductive contacting part is connected to the conductive fastening part via fastening.

According to one embodiment of the present invention, the conductive fastening part is a latch, and the conductive contacting part is a convex column.

According to one embodiment of the present invention, the conductive part includes a conductive column.

According to one embodiment of the present invention, the driving circuit board includes a plurality of conductive lugs, and the illuminant includes an illuminating part. The plurality of conductive lugs are used for connecting to the illuminating part.

According to one embodiment of the present invention, the illuminant is a light emitting diode light.

### BRIEF DESCRIPTION OF THE DRAWINGS

FIG. 1 illustrates a schematic drawing of the lamp according to one embodiment of the present invention.

FIG. 2 illustrates a cross-sectional drawing of the lamp according to one embodiment of the present invention.

FIG. 3 illustrates an exploded perspective view of the lamp according to one embodiment of the present invention.

FIG. 4 illustrates a schematic drawing of the illuminating part and the driving circuit board according to one embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

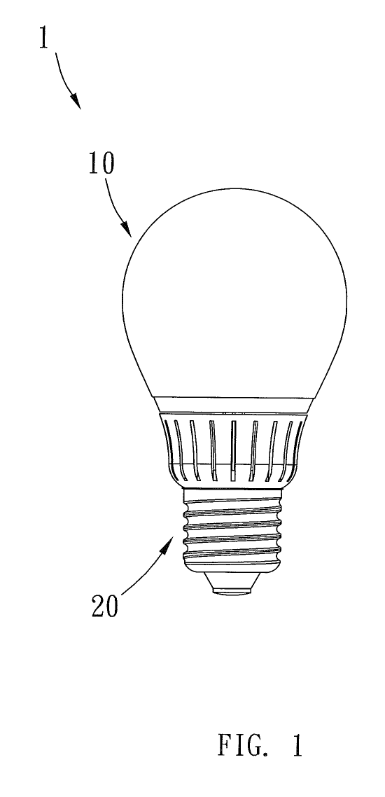

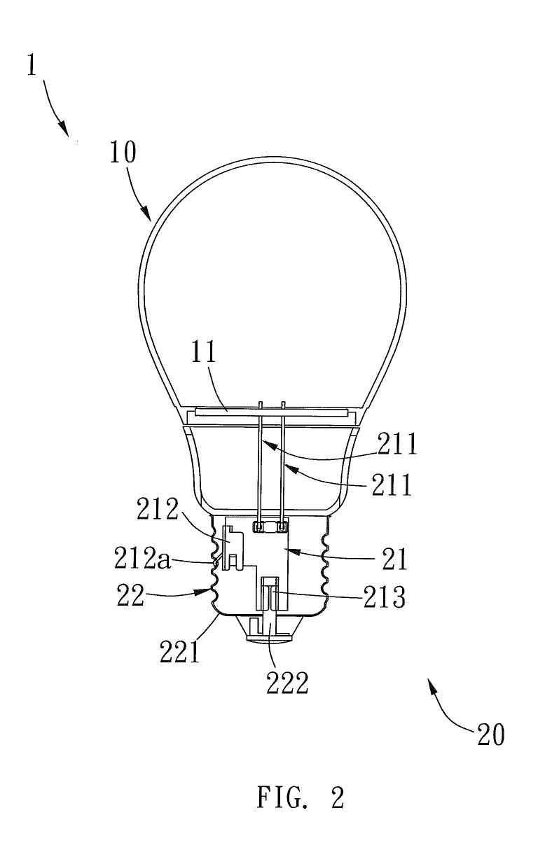

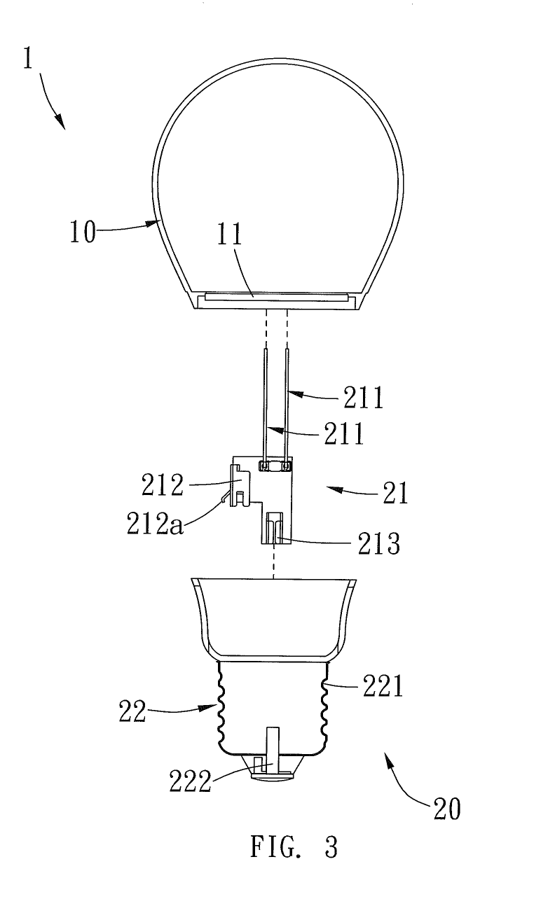

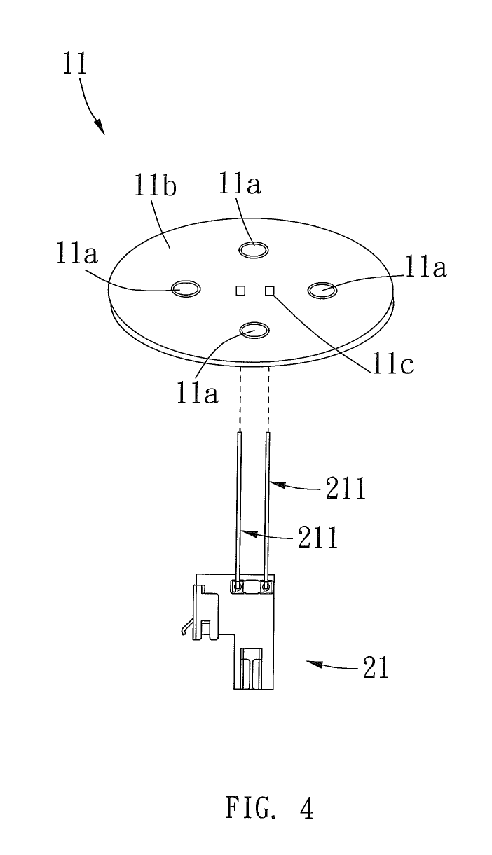

Please refer to FIG. 1 to FIG. 4 about the lamp of one embodiment of the present invention. FIG. 1 illustrates a schematic drawing of the lamp according to one embodiment of the present invention. FIG. 2 illustrates a cross-sectional drawing of the lamp according to one embodiment of the present invention. FIG. 3 illustrates an exploded perspective view of the lamp according to one embodiment of the present invention. FIG. 4 illustrates a schematic drawing of the illuminating part and the driving circuit board according to one embodiment of the present invention.

As shown in FIG. 1 to FIG. 4, in one embodiment of the present invention, the lamp 1 includes an illuminant 10 and a lamp holder 20. The illuminant 10 of the present invention is a light emitting diode light; but the type of the illuminant 10 of the present invention is not limited to the light emitting diode light, the illuminant 10 can also be an incandescent bulb or a halogen bulb. The illuminant 10 includes an illuminating part 11, as shown in FIG. 4, in the embodiment of the present invention, the illuminating part 11 is a substrate 11b with a plurality of light emitting diodes 11a. The substrate 11b has a connecting structure 11c, and the connecting structure 11c of the present invention is a slot set; but the type of the illuminating part 11 is not limited to the abovementioned design. In the prior art of the present invention, the illuminant 10 of the lamp 1 is already disclosed, so there is no need for further description.

In the embodiment of the present invention, the lamp holder 20 of the present invention includes a driving circuit board 21 and a base body 22. The driving circuit board 21 of the present invention can include a rectifier, a voltage regulator, and a transformer. The rectifier is used for converting the alternating current to the direct current, and delivering the power to the illuminant 10. The voltage regulator is used for keeping the voltage stable. The transformer is used for changing the voltage and the impedance. But the type and the function of the driving circuit board 21 is not limited to the abovementioned description. The driving circuit board 21 includes two conductive lugs 211, a conductive part 212, and a conductive fastening part 213; however, the amount of the conductive lug 211, the conductive part 212, and the conductive fastening part 213 are not limited to that design, the amount can be changed based on the requirement. In the present embodiment, the conductive lugs 211 are used for connecting to the slot set of the connecting structure 11c of the illuminating part 11, to deliver the power to the illuminating part 11, allowing the light emitting diode 11a to light. The conductive part 212 is used for conducting the circuit, and the conductive part 212 includes a conductive column 212a. In the embodiment of the present invention, the conductive fastening part 213 is a latch with a slot.

The base body 22 of the present invention includes a conductive case 221 and a conductive contacting part 222. In the embodiment of the present invention, the conductive column 212a of the conductive part 212 is used for connecting to the conductive case 221 via contacting, to conduct the circuit. The conductive contacting part 222 of the present invention is a convex column (such as a male connector), for combining with the latch of the conductive fastening part 213. The convex column of the conductive contacting part 222 is used for contacting and fastening to the latch of the conductive fastening part 213, allowing the circuit to be conducted. Via the connecting between the conductive column 212a and the conductive case 221, and the connecting between the conductive contacting part 222 and the conductive fastening part 213 (in the present embodiment, the connecting is formed via fastening), an integral conducting circuit can be completed. However, the structure of the conductive contacting part 222 and the conductive fastening part 213 of the present invention is not limited to the abovementioned description, for example, the conductive contacting part 222 can be a latch, and the conductive fastening part 213 can be a convex column corresponding to the latch, the conductive contacting part 222 and the conductive fastening part 213 can also be other structure with the fastening function.

When the user wants to assemble the lamp 1 of the present invention, the user only needs to let the conductive fastening part 213 of the driving circuit board 21 contact and fasten to the conductive contacting part 222 of the base body 22, such that the conductive column 212a of the driving circuit board 21 can contact to the conductive case 221; then, the user may let the illuminating part 11 of the illuminant 10 connect to the conductive lug 211 of the driving circuit board 21, such that the assembly process of the lamp 1 of the present invention can be completed. Therefore, via the structure of the lamp 1 of the present invention, the lamp 1 can be assembled quickly via the manual or automatic method, to greatly reduce the time and cost of assembly process.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A lamp holder, for connecting to an illuminant, the lamp holder comprising:
a driving circuit board, for connecting to the illuminant, the driving circuit board comprising a conductive part and a conductive fastening part; and
a base body, comprising:
a conductive case, wherein the conductive part is connected to the conductive case; and
a conductive contacting part, for connecting to the conductive fastening part.

2. The lamp holder as claimed in claim 1, wherein the conductive contacting part is connected to the conductive fastening part via fastening.

3. The lamp holder as claimed in claim 2, wherein the conductive fastening part is a latch, and the conductive contacting part is a convex column.

4. The lamp holder as claimed in claim 2, wherein the conductive part comprises a conductive column.

5. The lamp holder as claimed in claim 1, wherein the conductive part comprises a conductive column.

6. The lamp holder as claimed in claim 1, wherein the driving circuit board further comprises a plurality of conductive lugs, the illuminant further comprises an illuminating part, the plurality of conductive lugs are used for connecting to the illuminating part.

7. The lamp holder as claimed in claim 4, wherein the driving circuit board further comprises a plurality of conductive lugs, the illuminant further comprises an illuminating part, the plurality of conductive lugs are used for connecting to the illuminating part.

8. The lamp holder as claimed in claim 5, wherein the driving circuit board further comprises a plurality of conductive lugs, the illuminant further comprises an illuminating part, the plurality of conductive lugs are used for connecting to the illuminating part.

9. The lamp holder as claimed in claim 6, wherein the illuminant is a light emitting diode light.

10. A lamp, comprising:
an illuminant; and
a lamp holder, comprising:
a driving circuit board, connected to the illuminant, the driving circuit board comprising a conductive part and a conductive fastening part; and
a base body, comprising:
a conductive case, wherein the conductive part is connected to the conductive case; and
a conductive contacting part, for connecting to the conductive fastening part.

11. The lamp as claimed in claim 10, wherein the conductive contacting part is connected to the conductive fastening part via fastening.

12. The lamp as claimed in claim 11, wherein the conductive fastening part is a latch, and the conductive contacting part is a convex column.

13. The lamp as claimed in claim 11, wherein the conductive part comprises a conductive column.

14. The lamp as claimed in claim 10, wherein the conductive part comprises a conductive column.

15. The lamp as claimed in claim 10, wherein the driving circuit board further comprises a plurality of conductive lugs, the illuminant further comprises an illuminating part, the plurality of conductive lugs are used for connecting to the illuminating part.

16. The lamp as claimed in claim 13, wherein the driving circuit board further comprises a plurality of conductive lugs, the illuminant further comprises an illuminating part, the plurality of conductive lugs are used for connecting to the illuminating part.

17. The lamp as claimed in claim 14, wherein the driving circuit board further comprises a plurality of conductive lugs, the illuminant further comprises an illuminating part, the plurality of conductive lugs are used for connecting to the illuminating part.

18. The lamp as claimed in claim 15, wherein the illuminant is a light emitting diode light.
